(19) United States
(12) Patent Application Publication
(10) Pub. No.: US 2017/0175433 A1
(43) Pub. Date: Jun. 22, 2017

(54) GARAGE DOOR MONITORING SYSTEM

(71) Applicant: Pinning Inc., Daejeon (KR)

(72) Inventors: Jee Hoon Kang, San Jose, CA (US); Baik Hoh, San Jose, CA (US)

(73) Assignee: Pinning Inc., Daejeon (KR)

(21) Appl. No.: 15/382,273

(22) Filed: Dec. 16, 2016

Related U.S. Application Data
(60) Provisional application No. 62/268,407, filed on Dec. 16, 2015.
(60) Provisional application No. 62/277,356, filed on Jan. 11, 2016.
(60) Provisional application No. 62/347,533, filed on Jun. 8, 2016.

(51) Int. Cl. E05F 15/77; G06Q 50/28; G06Q 10/10; E05F 15/603; E05F 15/00

(52) U.S. Cl. CPC E05F 15/77; E05F 15/603; E05F 15/00; G06Q 10/1097; G06Q 50/28; E05Y 2900/106

(57) ABSTRACT

Methods, systems, and apparatus, including computer programs encoded on a computer storage medium, for garage door monitoring. In one aspect, a method includes the actions of obtaining garage door status data from one or more sensors; generating first status information based on the garage door status data, the first status information indicating initial status of a garage door; generating second status information based on the garage door status data, the second status information indicating that a garage door opener has started an operation; generating third status information based on the garage door status data, the third status information indicating a time duration that the garage door opener has operated since the garage door opener started an operation; and determining current status of the garage door based on (i) the first status information, (ii) the second status information, and (iii) the third status information.

### CROSS-REFERENCE TO RELATED APPLICATIONS

This application claims the benefit under 35 U.S.C. §119(e) of the filing date of U.S. Patent Application No. 62/268,407, which was filed on Dec. 16, 2015, U.S. Patent Application No. 62/277,356, which was filed on Jan. 11, 2016, and U.S. Patent Application No. 62/347,533, which was filed on Jun. 8, 2016. The disclosures of the foregoing applications are incorporated here by reference.

### BACKGROUND

This specification relates to equipment sensing and data communications.

A conventional garage door opener controls opening and closing operations of a garage door in response to user's input. The user's input can be received, for example, from a mounted control button or from a remote controller. When the garage door opener receives a signal to open the garage door, the garage door opener activates a motor that opens the garage door. When the garage door opener receives a signal to close the garage door, the garage door opener closes the garage door.

Conventionally, the garage door opener is mechanically coupled to the garage door to open or close the garage door. The garage door opener drives a mechanism to move the garage door upwardly or downwardly using the motor inside the garage door opener.

### SUMMARY

In general, one innovative aspect of the subject matter described in this specification can be embodied in methods that include the actions of obtaining garage door status data from one or more sensors; generating first status information based on the garage door status data, the first status information indicating initial status of a garage door; generating second status information based on the garage door status data, the second status information indicating that a garage door opener has started an operation; generating third status information based on the garage door status data, the third status information indicating a time duration that the garage door opener has operated since the garage door opener started an operation; and determining current status of the garage door based on (i) the first status information, (ii) the second status information, and (iii) the third status information. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. The garage door status data includes a value of current, obtaining garage door status data including: sensing current provided from a power source to the garage door opener. The garage door status data includes magnetic information including a value of a magnetic field or a value of a magnetic flux, obtaining garage door status data including: obtaining the magnetic information near a current line connecting a power source to the garage door opener. The garage door status data includes images, obtaining garage door status data including: obtaining images of the garage door. The garage door status data includes sound data, obtaining garage door status data including: detecting sound inside a garage. Generating first status information based on the garage door status data includes: determining characteristics of the garage door status data, and determining the initial status of the garage door based on the characteristics of a current. The characteristics of the garage door status data include a waveform of a current, brightness of an image, contrast of an image, or a sound pattern. Generating second status information based on the garage door status data including: determining whether the garage door status data satisfies a threshold, and determining whether the garage door opener has started an operation based on the determination that the garage door status data satisfies the threshold. Determining current status of the garage door includes: determining the time duration that the garage door opener has operated since the garage door opener started an operation satisfies one or more thresholds. The method further includes providing the current status of the garage door to an external device. The method further includes obtaining, by a detecting device from an external device, server access information; accessing, by the detecting device, a server using the server access information; providing, by the detecting device to the server, authentication information; and providing, by the detecting device to the external device, the authentication information. The detecting device further provides location information to the server and the external device. The method further includes receiving the current status of the garage door; generating a first notification based on the current status of the garage door; and providing the first notification to a vehicle system. The method further includes receiving the current status of the garage door; obtaining contextual information that is associated with a user behavior, a user location, user preferences, or a user schedule; generating a second notification based on the current status of the garage door and the contextual information; and provide the second notification to a vehicle system. The method further includes receiving, from a detecting device by a receiver, the current status of the garage door; receiving, from the detecting device by the receiver, a radio signal, a strength of the radio signal varies based on a distance between the detecting device and the receiver; determining a vehicle location based on the radio signal; generating contextual information that is associated with the vehicle location; generating a second notification based on the current status of the garage door and the contextual information; and providing the second notification to a vehicle system. The method further includes: obtaining magnetic information from a vehicle near the garage door; and updating the contextual information that is associated with a vehicle location based on the magnetic information. The method further includes: determining whether the current status of the garage door can be determined based on (i) the first status information, (ii) the second status information, and (iii) the third status information; and performing, based on the determination that the current status of the garage door can be determined based on (i) the first status information, (ii) the second status information, and (iii) the third status information, a recovery process using a most recent current status of the garage door and a time duration that the garage door has stopped. Performing a recovery process using a most recent current status of the garage door includes: obtaining one or more threshold values; comparing each value of the one or more threshold values to the time duration that the garage door has stopped; and determining the current status of the garage door based on results of comparing each value of the one or more threshold values to the time duration. The method further includes: receiving a request to open the garage door; obtaining size information of a package; and opening the garage door based on the size information of the package. The method further includes: obtaining a delivery schedule of the package; determining whether the package is scheduled to be delivered based on the delivery schedule; determining whether the garage door is opened or closed based on the determination that the package is scheduled to be delivered; generating a notification indicating whether the garage door is opened or closed based on the determination that the garage door is opened; and providing the notification to a vehicle system or a user device.

Particular embodiments of the subject matter described in this specification can be implemented so as to realize one or more of the following advantages. Compared to a conventional garage door monitoring system, a garage door monitoring system can work with any suitable garage door opener. The garage door monitoring system can detect data to determine current status of a garage door from a pre-existing garage door opener using a detecting device without wiring to connect the detecting device with the pre-existing garage door opener, installing additional sensors to a garage door, or disassembling the pre-existing garage door opener. Based on the data detected by the detecting device, the garage door monitoring system can accurately determine current status of the garage door.

In addition, the garage door monitoring system can provide notifications about the current status of the garage door. The notifications can include not only factual information, but also contextual information, which indicates information associated with context such as a user's location and schedule. Thus, the garage door monitoring system can provide enhanced personalized user experience to a user.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a diagram providing an overview of an example garage door monitoring system.

FIG. 1B is a diagram providing an example garage door monitoring system.

FIG. 2 is a diagram illustrating an example detecting device.

FIG. 3 is a diagram illustrating an example server.

FIG. 4 is a diagram illustrating an example state machine for a garage door status monitoring engine.

FIG. 5 is a diagram illustrating an example method of establishing secured connections among a user device, a detecting device, and a server.

Like reference symbols in the various drawings indicate like elements.

### DETAILED DESCRIPTION

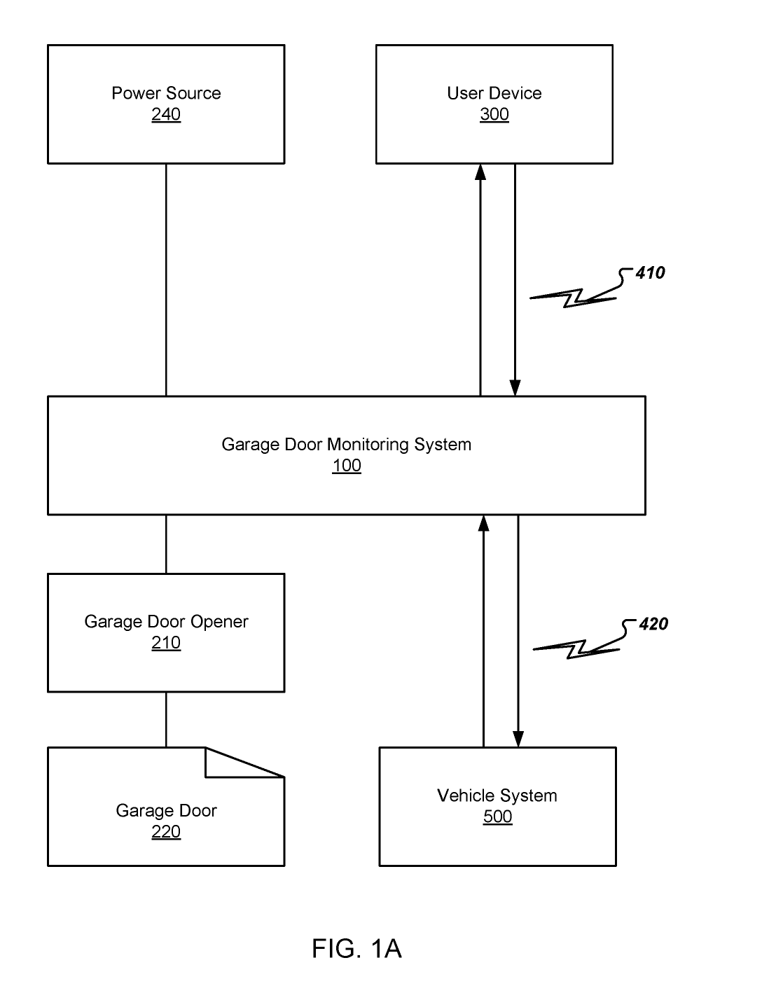

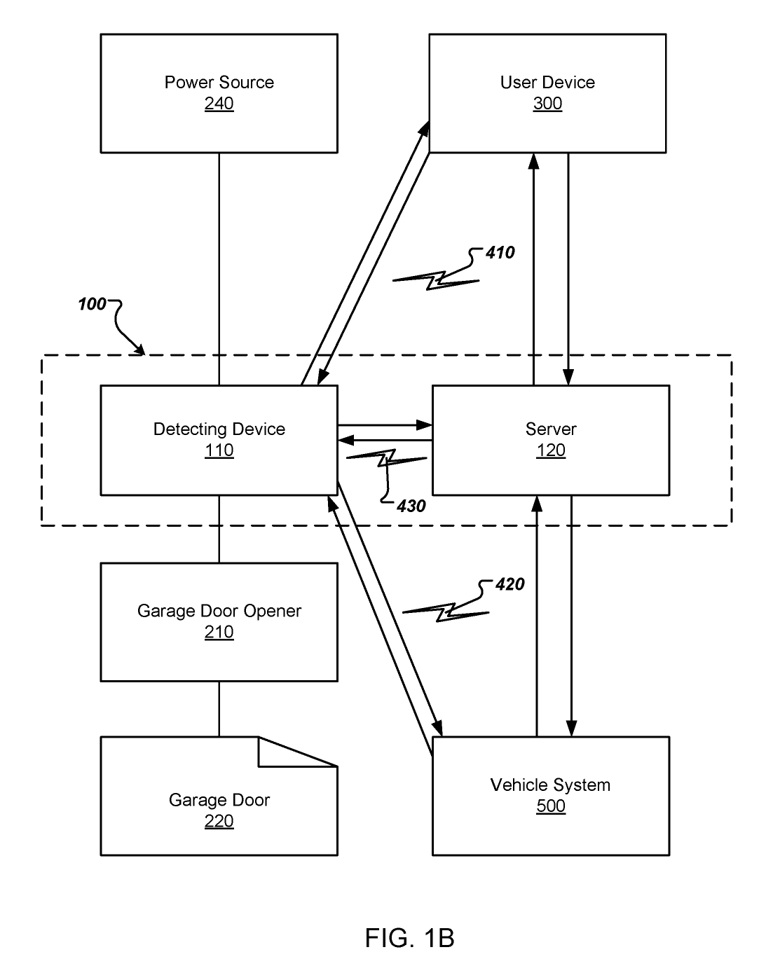

FIG. 1A is a diagram providing an overview of an example garage door monitoring system. A garage door monitoring system 100 is configured to detect data from a garage door opener 210 and determine current status of the garage door 220 based on the detected data. The garage door monitoring system 100 is also configured to generate notifications and send the notifications to a user device 300 over one or more first networks 410. A user of the user device 300 can verify the current status of the garage door 220 using the user device 300 and/or a vehicle system 500. The vehicle system 500 can be coupled to or integrated with a variety of vehicles including vehicles associated with a user of the garage door monitoring system 100. In some implementations, the garage door monitoring system 100 can provide an application or a computer program running on the user device 300 or the vehicle system 500. The user of the user device 300 or the vehicle system 500 can view visual notifications and other information using a graphic user interface provided by the application or the computer program running on the user device 300. In some implementations, the user of the user device 300 or the vehicle system 500 can receive audio notifications or vibrating notifications in addition to or in place of visual notifications. The user of the user

In some implementations, in response to the notifications sent from the garage door monitoring system 100, the user device 300 and/or the vehicle system 500 can provide feedback information to the garage door monitoring system 100. The feedback information may include a distance between the garage door monitoring system 100 and the user device 300 or the vehicle system 500. For example, the distance can be calculated using GPS signals from the user device 300 or the vehicle system 500. The location of at least a local portion of the garage door monitoring system 100 can be established in a number of ways including providing address information during setup or configuration or through a local GPS receiver. The address information provided during setup can include a user input to an application or website associated with the garage door monitoring system 100 as well as address information derived from network information such as IP address information associated with a Wi-Fi access point in communication with the garage door monitoring system 100.

For another example, the distance can be calculated by signals that sent and received between the garage door monitoring system 100 and the user device 300 or the vehicle system 500. The garage door monitoring system 100 can change characteristics of the notification, e.g., frequency, content, intensity, or volume of the notification, based on the feedback information. For example, if the vehicle moves away from the garage without closing the garage door 220, the garage door monitoring system 100 can send the notifications more frequently.

The granularity of the distance measure can vary, for example, from a precision GPS measurement to a more general estimation. For example, the vehicle system 500 can include the ability to transmit signals at different power levels (e.g., by varying the RF power to transmission from a single transmitter or by including more than one RF transmitter operating at respective transmission power). Depending on whether communication is received by the garage door monitoring system 100 at one power level or both power levels can provide an indication of whether the vehicle system 500 is nearby or farther away. The type and nature of notifications provided by the garage door monitoring system can vary depending on the whether the vehicle system 500 is nearby or farther away.

The one or more first networks 410 can be phone and/or computer networks including wireless cellular networks, wireless local area networks (WLAN) or Wi-Fi networks, wired Ethernet networks, other wired networks, or any suitable combination thereof. Thus, the user of the user device 300 can verify the current status of the garage door 220 even if the user is located in a remote location from the garage door 220.

In some implementations, the garage door monitoring system 100 can send notifications to a vehicle system 500 over one or more second networks 420. The one or more second networks 420 can be phone and/or computer networks including wireless cellular networks, WLAN or Wi-Fi networks, wired Ethernet networks, other wired networks, or any suitable combination thereof. In addition, the vehicle system 500 can communicate with the garage door monitoring system 100 using any suitable techniques. For example, the vehicle system 500 can communicate with the garage door monitoring system 100 using a dedicated communication channel for the notifications. For another example, the vehicle system 500 can communicate with the garage door monitoring system 100 using other communication channels for other types of data.

In some implementations, the garage door monitoring system 100 can send notifications to a receiver over the one or more second networks 420. The receiver can communicate with the garage door monitoring system 100 any suitable techniques including using a dedicated communication channel for the notifications or using other communication channels for other types of data. The receiver is configured to receive the notifications and provide the received notifications to the vehicle system 500. In some implementations, the receiver can be electrically coupled to the vehicle system 500 and can communicate with the vehicle system 500 using a wired channel. In some implementations, the receiver can communicate with the vehicle system 500 using any suitable wireless channels including WLAN, Wi-Fi, or Bluetooth.

In some implementations, the garage door monitoring system 100 can send the current status of the garage door 220 to a receiver. In this example, the receiver can be a part of the vehicle system 500 or can communicate with the vehicle system 500. The receiver can generate notifications and provide the notifications to the vehicle system 500. The receiver can use contextual information, e.g., a vehicle location, to generate the notifications. For example, the receiver can send a radio signal to the garage door monitoring system 100 and receive a return signal from the garage door monitoring system 100. The receiver can determine a distance between the receiver and the garage door monitoring system 100 based on a strength of the return signal. Using the distance between the receiver and the garage door monitoring system 100, the receiver determines a vehicle location, e.g., whether the vehicle is inside a garage or away from the garage. The receiver can generate notifications based on the current status of the garage door 220 and the vehicle location. For example, if the vehicle is away from the garage and the current status of the garage door 220 indicates that the garage door 220 is open, the receiver generates notifications indicating that the garage door 220 is open and should be closed. The receiver communicates with the vehicle system 500 and provide the notifications to the vehicle system 500 for a user.

In some implementations, the user device 300 can be the receiver that communicates with the vehicle system 500. The user device 300 can receive the notifications from the garage door monitoring system 100 and provide the received notifications to the vehicle system 500.

In some implementations, a user of the user device 300 or the vehicle system 500 can request the garage door monitoring system 100 to send a notification about current status of the garage door 220. The user can use the application or the computer program running on the user device 300 to request the notification. When the garage door monitoring system 100 receives the request, the garage door monitoring system 100 determines the current status of the garage door 220 and provides the current status as a notification to the user.

In some implementations, the garage door monitoring system 100 can communicate with an application or a computer program running on the user device 300 or the vehicle system 500 to provide control for the garage door 220. The application or the computer program provides, to the user, a graphic user interface that allows the user to open or close the garage door 220 without using a remote controller for the garage door opener 210.

In addition, the application or the computer program provides, to the user, a graphic user interface that allows the user to partly open or close the garage door 220. When the application or the computer program allows the user to partly open or close the garage door 220, the application or the computer program may provide, to the user, a graphic user interface that allows the user to set the exact height that the garage door 220 is open.

This ability to partially open or close the garage door 220 can be used to allow third party access, for example, to provide package delivery or pickup. For example, when a delivery vehicle is near the garage door 220 to deliver a package, a request to open the garage door 220 can be sent to the garage door monitoring system 100. In some implementations, the request is sent by the user, e.g., the homeowner, though the graphical user interface in response to a notification from the delivery driver. In some other implementations, the user can authorize particular third parties such as particular delivery services such that the garage door can be partially opened in response to the presence of the delivery vehicle. For example, the delivery vehicle can communicate with the garage door monitoring system 100. If the delivery vehicle is authorized and if the delivery vehicle location corresponds to a location proximate to the garage door 200, then the garage door 200 can be partially opened to receive the delivered package.

The user can specify how much the garage door 220 should be opened to allow delivered packages to be slid inside the garage. In some implementations, the garage door monitoring system 100 can obtain size information of the package, for example, from the delivery service, and can determine the exact height that the garage door 220 should be opened to accommodate the particular package. In this example, the user does not have to control how much the garage door 220 should be opened. The user only needs to allow whether the garage door 220 should be opened and the garage door monitoring system 100 determines the height and opens the garage door 220 to the height.

In some implementations, the garage door monitoring system 100 can obtain size information of the package and the delivery schedule, for example, from purchase receipt records or shipment tracking records obtained from the user or an authorized third party (e.g., retail establishment or delivery service). When the request to open the garage door 220 is received by the garage door monitoring system 100, the garage door monitoring system 100 validates whether the delivery has been scheduled. Once the delivery is validated, the garage door monitoring system 100 determines the height that the garage door 220 should be opened for that particular package and opens the garage door 220 to the height.

To control the garage door 220, the garage door monitoring system 100 can be coupled to the garage door opener 210. For example, the garage door monitoring system 100 can be coupled to the garage door opener using cables or other wired or wireless coupling. When the garage door monitoring system 100 receives a control signal from the user device 300, the garage door monitoring system 100 can control the garage door opener 210 by communicating with the garage door opener 210 using the cables.

In some implementations, the garage door monitoring system 100 can control the garage door opener 210 using a third-party server. For example, when the garage door monitoring system 100 receives a first control signal from the user device 300, the garage door monitoring system 100 can send a second control signal to the third-party server based on the first control signal. Based on the second control signal, the third-party server can be connected to the garage door opener 210 and controls the garage door opener 210 to operate opening or closing the garage door 220.

In some other implementations, the garage door monitoring system 100 can physically control a remote controller, which is configured to open or close the garage door 220. For example, when a remote controller is within a certain distance from the garage door monitoring system 100, the garage door monitoring system 100 can be configured to physically control, e.g., push a control button on the remote controller, the remote controller using a robot arm of the garage door monitoring system 100.

The user device 300 may be any suitable type of computing device, including but not limited to a mobile phone, a smartphone, a tablet computer, a music player, an e-book reader, a laptop or desktop computer, PDA, or other handheld or mobile device, that includes one or more processors and computer readable media.

Garage Door Monitoring System

FIG. 1B is a diagram providing an example garage door monitoring system. The garage door monitoring system 100 includes a detecting device 110 and a server 120. In some implementations, the garage door monitoring system 100 may include a detecting device 110 without including a server 120. In these implementations, the detecting device 110 may include all the necessary elements of a server 120.

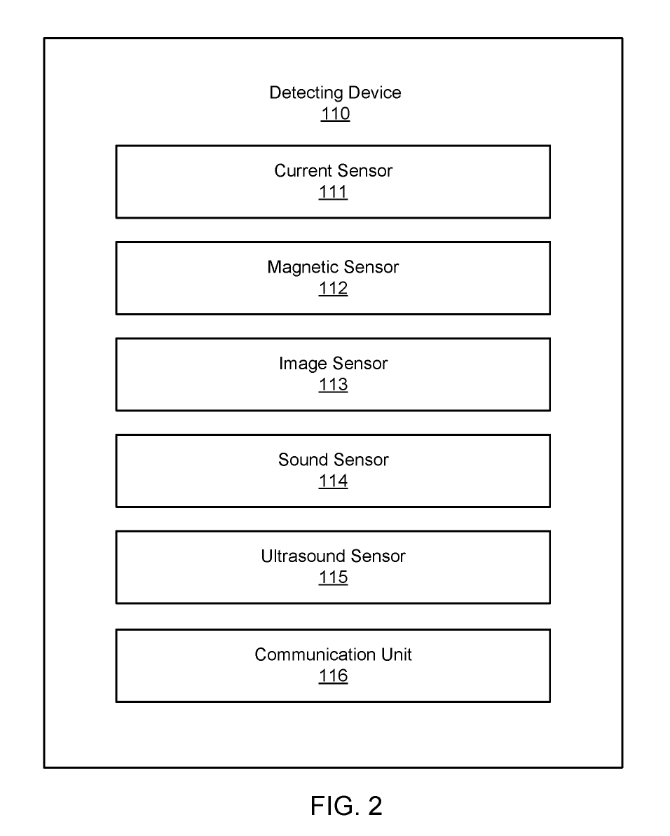

The detecting device 110 is configured to obtain garage door status data to determine current status of the garage door 220. The garage door status data may include (i) current provided from a power source to a garage door opener 210, (ii) a magnetic field or a magnetic flux caused by current provided from a power source to a garage door opener 210, (iii) visual images of the garage door 220, (iv) sounds inside a garage, and (v) ultrasounds inside a garage. The detecting device 110 may include sensors to detect the garage door status data. For example, the detecting device 110 may include one or more of a current sensor, a magnetic sensor, an image sensor, a sound sensor, and an ultrasound sensor. Methods of detecting the garage door status data using these sensors will be described in greater detail with regard to FIG. 2.

The detecting device 110 can send the garage door status data to the server 120 over one or more third networks 430. For example, the detecting device 110 can send the garage door status data in response to detection or can send the garage door status data according to a specified schedule or upon request of the server 120. The one or more third networks 430 can be phone and/or computer networks including wireless cellular networks, WLAN or Wi-Fi networks, wired Ethernet networks, other wired networks, or any suitable combination thereof. In some implementations, the one or more first networks 410 can be different from the one or more third networks 430. For example, the first networks 410 can be wireless cellular networks and the third networks 430 can be WLAN or Wi-Fi networks. In some other implementations, the one or more first networks 410 and the one or more third networks 430 can be the same networks. For example, both the first networks 410 and the third networks 430 can be wireless cellular networks. In response to receiving the garage door status data from the detecting device 110, the server 120 is configured to determine current status of the garage door 220. The status can include, e.g., open, closed, opening, closing, or stopped, based on the garage door status data.

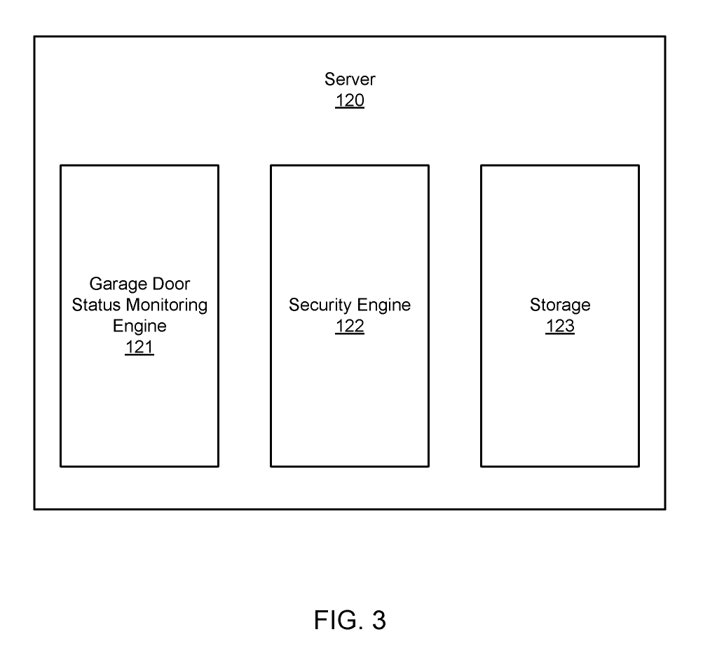

In some implementations, when the server 120 receives the garage door status data including one or more of (i) current provided from a power source to a garage door opener 210, (ii) a magnetic field or a magnetic flux caused by current provided from a power source to a garage door opener 210, (iii) visual images of the garage door 220, and (iv) sounds inside a garage, the server 120 may give a weight to each different type of status data and determine the current status of the garage door 220 based on the weighted garage door status data. Methods of determining current status of the garage door 220 will be described in greater detail with regard to FIG. 3.

The server 120 can send notifications to the user device 300 over the one or more first networks 410 and/or the vehicle system 500 over the one or more second networks 420. The notifications can be sent whenever there is an update of current status of the garage door 220 or only when a user requests current status of the garage door 220 to the garage door monitoring system 100.

In some implementations, the detecting device 110, instead of the server 120, can give a weight to each different type of status data and determine the current status of the garage door 220 based on the weighted garage door status data. In this example, the detecting device 110 directly sends the notifications to the user device 300 over the one or more first networks 410. In some other implementations, the detecting device 100 can send notifications, over the one or more second networks 420, (i) to a receiver that communicates with the vehicle system 500 or (ii) directly to the vehicle system 500.

In some implementations, the detecting device 110 can send the current status of the garage door 220 to a receiver that communicates with the vehicle system 500 or is a part of the vehicle system 500. The receiver can generate notifications using contextual information and provide the notifications to the vehicle system 500.

A notification that is sent to the user device 300 or the vehicle system 500 can be either one of two types of notifications, i.e., a first notification or a second notification. In some implementations, the first notification and the second notification can be generated by the garage door monitoring system 100. In some other implementations, the first notification and the second notification can be generated by a receiver that communicates with the vehicle system 500 or that is a part of the vehicle system 500.

A first notification is factual information of current status of the garage door 220. For example, where a user opens the garage door 220 using a remote controller, the server 120 determines that the garage door 220 is opening. The server 120 may send the user the first notification indicating that the garage door 220 is opening now.

For another example, where a user requests the garage door monitoring system 100 to send information as to how many times the garage door 220 was opened between 9 a.m. and 5 p.m. on Jun. 2, 2016, the garage door monitoring system 100 may send the user the first notification indicating that the garage door was opened five times within the specified time period.

A second notification is contextual information of current status of the garage door 220. The second notification is information associated with contexts. Contexts may include a vehicle location, user's preferences, user's behaviors, a user's location, and a user's schedule. For example, a user, who lives in Sunnyvale, Calif., is on vacation in England and a thief opens the garage door 220. The garage door monitoring system 100 can associate current status of the garage door 220, i.e., the garage door 220 is opening, with the contexts, e.g., the user's schedule indicates that the user is on vacation and the user's current location is away from the garage door 220. When the garage door monitoring system 100 determines that the opening of the garage door 220 is not normal based on the contexts, the garage door monitoring system 100 can send the user the second notification alerting the user that the garage door 220 is being opened without a permission. The garage door monitoring system can additionally provide a graphic user interface on the user device 300 and/or the vehicle system 500, which allows the user to contact a local police or a private security company.

For another example, a user forgets to close the garage door 220 and then drives a few miles away from the garage door 220. The garage door monitoring system 100 can associate current status of the garage door 220, i.e., the garage door 220 is open, with the context, e.g., the user's location is away from the garage door 220. In some implementations, the garage door monitoring system 100 can obtain the user's location using a GPS signal from the user device 300 or the vehicle system 500. In some other implementations, the user's location can be inferred using a magnetic sensor. The details of inferring the user's location using the magnetic sensor will be described in greater detail with regard to FIG. 2. When the user drives away from the garage door 220 more than a specific distance, the garage door monitoring system 100 can send the user the second notification alerting that the user forgets to close the garage door 220. The garage door monitoring system can additionally provide a graphic user interface on the user device 300, which allows the user to control the garage door 220 remotely.

For another example, when more than one user is registered in the garage door monitoring system 100, the garage door monitoring system 100 can selectively send the second notification to a specific user. If a first user leaves home and closes the garage door 220 while a second user stays at home, the garage door monitoring system 100 can associate current status of the garage door 200, e.g., the garage door 220 is closing, with the context, e.g., a first user's location and a second user's location. When the first user drives away from the garage door 220, the garage door monitoring system 100 can send the second notification only to the first user based on the first user's location and the second user's location. The garage door monitoring system 100 can provide, to the user device 300, an application or a computer program that allows a user to select receiving a second notification.

For another example, when a user controls to open the garage door 220 and leaves home to go to work at 7 a.m., the garage door monitoring system 100 can associate current status of the garage door 220, i.e., the garage door 220 is opening, with the context, i.e., user's behaviors at a specific time. The garage door monitoring system 100 may can send the user a second notification including navigation information to a destination or today's schedule.

In some implementations, the garage door monitoring system 100 can be configured to send more than one second notifications to a user. When the garage door monitoring system 100 sends more than one second notifications to the user, the garage door monitoring system 100 can be configured to change frequency of sending second notifications. For example, the garage door monitoring system 100 can increase the frequency of sending second notifications as a user is away from the garage door 220.

Detecting Device

FIG. 2 is a diagram illustrating an example detecting device of a garage door monitoring system. The detecting device 110 may include one or more sensors and a communication unit 116. The one or more sensors are configured to detect garage door status data including one or more of (i) current provided from a power source to a garage door opener 210, (ii) a magnetic field or a magnetic flux caused by current provided from a power source to a garage door opener 210, (iii) visual images of the garage door 220, (iv) sounds inside a garage, and (v) ultrasounds inside a garage. To detect the garage door status data, the detecting device may include one or more corresponding sensors including a current sensor 111, a magnetic sensor 112, an image sensor 113, a sound sensor 114, an ultrasound sensor 115, or any combination of the sensors 111-115. The communication unit 116 is configured to send the garage door status data to the server 120 or receive instructions for controlling the sensors from the server 120.

The current sensor 111 is configured to detect current provided from a power source 240, e.g., a power outlet in a garage, to the garage door opener 210. To detect the current, the detecting device 110 can be coupled between the power source 240 and the garage door opener 130. For example, one side of the detecting device 110 can be coupled to the power source 240 and the other side of the detecting device 110 can be coupled to the garage door opener 210. Since the detecting device 110 is coupled between the garage door opener 210 and the power source 240, the current provided from the power source 240 to the garage door opener 210 passes through the detecting device 110. Thus, the current sensor 111 can detect the current provided to the garage door opener 210 by measuring the current that passes through the detecting device 110. If the current is an alternating current, the current sensor 111 can detect a waveform, a period, a peak value, spectral density of the current.

The magnetic sensor 112 is configured to detect a magnetic field or a magnetic flux caused by current provided from the power source 240 to the garage door opener 210. To detect the magnetic field or the magnetic flux, the detecting device 110 can be coupled between the power source and the garage door opener 130. For example, one side of the detecting device 110 can be coupled to the power source 240 and the other side of the detecting device 110 can be coupled to the garage door opener 210. Since the detecting device 110 is coupled between the garage door opener 210 and the power source 240, the current provided from the power source 240 to the garage door opener 210 passes through the detecting device 110. Thus, the magnetic sensor 112 can detect the magnetic field or the magnetic flux caused by the current that passes through the detecting device 110. In particular, the detecting device 110 may include wires that connect the garage door opener 210 to the power source 240. The magnetic sensor 112 can be configured to detect the magnetic field or the magnetic flux near the wires. The magnetic sensor 112 can be placed between the wires that connects the garage door opener 210 and the power source 240. In some implementations, a power plug of the garage door opener 210 is coupled to the detecting device 110. The magnetic sensor 112 can be located at a position that is between two prongs of the power plug when the power plug is coupled to the detecting device. In some other implementations, the detecting device 110 can include multiple printed circuit boards (“PCBs”), for example, two or more PCBs in parallel with each other and orthogonal to the power plug receptacle. The magnetic sensor 112 can be located on the PCB that is the furthest from the power source 240 to reduce interference.

In some implementations, the magnetic sensor 112 is configured to detect magnetic flux caused by a metal object, e.g., a vehicle or the garage door 220. This magnetic flux can be used by the garage door monitoring system 100 to determine the contextual information. For example, the magnetic sensor 112 can detect magnetic flux caused by a vehicle. When a value of the magnetic flux satisfies is below a threshold, the garage door monitoring system 100 can determine the vehicle is away from the garage. When a value of the magnetic flux is over the threshold, the garage door monitoring system 100 can determine the vehicle is inside the garage. The garage door monitoring system 100 can use the location of the vehicle as contextual information to generate the second notification described above.

The image sensor 113 is configured to capture one or more images directed to the garage door 220. The image sensor 113 may be a camera to acquire images toward the garage door 220. For example, the image sensor 113 can be a digital camera with infrared capability. To capture images directed to the garage door 220, the image sensor 113 can be oriented toward the garage door 220. In some implementations, the garage door monitoring system 100 can capture images directed to the garage door 220 upon a user request. When the server 120 receives a user request for current status of the garage door 220, the image sensor 113 can be configured to capture images directed to the garage door 220. The communication unit 116 is configured to send the images to the server 120.

The sound sensor 114 is configured to detect sounds including sounds that indicate the garage door 220 is open or closed. For example, the sound sensor 114 may detect vehicle start or stop sounds, motor sounds of the garage door opener 210, closing or opening sounds from the garage door 220, background sounds, or reverb sounds. To detect sounds in the garage, the sound sensor 114 may include one or more microphones that are oriented toward same or different directions.

The ultrasound sensor 114 is configured to detect ultrasounds including sounds that indicate the garage door 220 is open or closed. For example, the ultrasound sensor 115 may be directed to the garage door 220 and send ultrasounds toward the garage door 220. The ultrasound sensor 115 is configured to measure a time period between sending the ultrasounds toward the garage door 220 and receiving the reflected ultrasounds from the garage door 220.

Server

FIG. 3 is a diagram illustrating an example server of a garage door monitoring system. The server 120 may include a garage door status monitoring engine 121, a security engine 122, and a storage 123. While a single server is illustrated in FIG. 3 for convenience, the operations of the server 120 can be performed in a distributed or cloud based system having one or more computers. In some implementations, the garage door monitoring system 100 may include a detecting device 110 without including a server 120. In these implementations, the detecting device 110 may include the garage door status monitoring engine 121, the security engine 122, and the storage 123.

When the server 120 receives the garage door status data detected by the one or more sensors, the garage door status monitoring engine 121 is configured to determine the current status of the garage door 220 based on the garage door status data. In some implementations, the garage door status monitoring engine 121 can determine the current status of the garage door 220 based on one type of data from one sensor. In some implementations, the garage door status monitoring engine 121 can determine the current status of the garage door 220 based on two or more types of data from two or more sensors.

When the garage door status monitoring engine 121 determines current status of the garage door 220 based on two or more types of data from two or more sensors, the garage door status monitoring engine 121 may assign a particular weight to each type of the data and determine the current status of the garage door 220 based on the weighted data. For example, the current sensor 111 detects current provided to the garage door opener 210, the image sensor 113 can capture images directed to the garage door 220, and the sound sensor 114 can detect sounds inside the garage. The garage door status monitoring engine 121 may receive current data as well as image data and sound data from the sensors 111, 113, 114. The garage door status monitoring engine 121 can assign particular weights to each type of the data. Then, the garage door status monitoring engine 121 determines the current status of the garage door 220 based on the weighted data. In this example, the current data may indicate that the garage door 220 is opening because the current sensor 111 detects the current provided to the garage door opener 210. The image data may indicate that the garage door 220 is opening because the images may show that the garage door 220 is opening. The sound data may indicate that the garage door 220 is opening because the sounds data may include motor sounds or shutter opening sounds from the garage door 220. Since all types of the data indicate that the garage door 220 is opening, the garage door status monitoring engine 121 can determine the current status of the garage door 220 as opening based on the weighted data.

For another example, when wires connecting the garage door opener 210 to the garage door 220 are disconnected, the garage door 220 does not move even if the garage door opener 210 operates. When the garage door status monitoring engine 121 receives current data as well as image data and sound data from the sensors 111, 113, 114, some data may indicate that the garage door 220 is opening, but other data may indicate that the garage door 220 is closed. In this example, the current data may indicate that the garage door 220 is opening because the current sensor 111 may detect the current provided to the garage door opener 210. In comparison, the image data and the sound data may indicate that the garage door 220 is closed because the images may show the closed garage door 220 and there may be no shutter opening sounds from the garage door 220. The garage door status monitoring engine 121 can assign particular weights to each type of the data. Then, the garage door status monitoring engine 121 determines the current status of the garage door 220 based on the weighted data. In this example, since two types of the data indicate that the garage door 220 is closed and one type of the data indicates that the garage door 220 is opening, the garage door status monitoring engine 121 can determine the current status of the garage door 220 as closed based on the weighted data. Thus, the garage door monitoring system 100 can improve accuracy of the determination by using multiple sensors and multiple types of data detected by the multiple sensors.

Determining the Current Status of a Garage Door

To determine current status of the garage door 220, the garage door status monitoring engine 121 generates first status information, second status information, and third status information based on the garage door status data. The first status information indicates initial status of the garage door 220, e.g., open or closed. The second status information indicates whether the garage door opener 210 has started any operation. The third status information indicates how long the garage door opener 210 has operated since the garage door opener 210 started the initial operation.

First Status Information

The garage door status monitoring engine 121 is configured to generate the first status information, which indicates initial status of the garage door 220, based on the garage door status data.

In some implementations, the garage door status monitoring engine 121 can determines the initial status of the garage door 220 based on the current data detected by the current sensor 111. When a motor of the garage door opener 210 operates, the motor rotates in different directions for opening or closing the garage door 220. Since the direction of motor rotation changes the characteristics, e.g., a waveform of current, of the current provided to the garage door opener 210, the garage door status monitoring engine 121 can determine whether the initial status of the garage door 220 is open or closed based on the characteristics of the current. Based on the initial status of the garage door 121, the garage door status monitoring engine 121 generates the first status information indicating the current status of the garage door 220.

In some implementations, the garage door status monitoring engine 121 may determine the initial status of the garage door 220 based on image characteristics such as brightness and contrast of images. For example, when the garage door 220 is open, the captured images may be bright because light goes through the open area that would have been covered by the garage door 220. In addition, when the garage door 220 is open, the open area is bright while an inside wall portion in a garage may be dark. Thus, the images can have high contrast. In comparison, when the garage door 220 is closed, the images may be dark because light cannot go through the garage door 220. In addition, when the garage door 220 is closed, both the garage door 220 and the inside wall portion in the garage may be dark. These images have low contrast. Thus, the garage door status monitoring engine 121 can determine whether the initial status of the garage door 220 is open or closed based on the image characteristics of the images. Based on the initial status of the garage door 121, the garage door status monitoring engine 121 generates the first status information indicating that the garage door opener 210 is open or closed

In some implementations, the garage door status monitoring engine 121 may determine the initial status of the garage door 220 based on sounds detected by the sound sensor 114. For example, sounds inside a closed garage have more reverberation than sounds inside an open garage. In addition, opening sounds from the garage door 220 are often distinctive from closing sounds from the garage door 220. Motor sounds of the garage door opener 210 are distinctive as well. Thus, the garage door status monitoring engine 121 can determine whether the initial status of the garage door 220 is open or closed based on the received sound data. Based on the initial status of the garage door 121, the garage door status monitoring engine 121 generates the first status information indicating that the garage door opener 210 is open or closed.

Second Status Information

The garage door status monitoring engine 121 determines whether the garage door opener 210 has started an operation based on the garage door status data. In some implementations, where the garage door opener 210 has started opening operation of the garage door 220, current is provided from the power source 240 to the garage door opener 210 to operate a motor of the garage door opener 210. The current sensor 111 detects the current change when the current is provided from the power source 240 to the garage door opener 210. The communication unit 116 of the detecting device 110 provides the garage door status data, i.e., the current change, to the server 120. The garage door status monitoring engine 121 determines whether the received current change satisfies a threshold to tell the current change from noise current.

For example, where the current change detected by the current sensor 111 is 1.5 A, if the threshold is 5 A, the garage door status monitoring engine 121 can determine that the garage door opener 210 has not started any opening or closing operation. The garage door status monitoring engine 121 generates the second status information indicating that the garage door opener 210 has not started any operation. On the other hand, where the current change detected by the current sensor 111 is 5.5 A, the garage door status monitoring engine 121 can determine that the garage door opener 210 has started opening or closing operation of the garage door 220. The garage door status monitoring engine 121 generates the second status information indicating that the garage door opener 210 has started an operation.

In some implementations, where the garage door opener 210 has started opening operation of the garage door 220, current provided from the power source 240 to the garage door opener 210 causes a magnetic field or a magnetic flux. The magnetic sensor 112 detects the change of the magnetic field or the magnetic flux caused by the current change occurred when the current is provided from the power source 240 to the garage door opener 210.

The communication unit 116 of the detecting device 110 provides the garage door status data, i.e., the change of the magnetic field or the magnetic flux, to the server 120. The garage door status monitoring engine 121 determines whether the received change of the magnetic field or the magnetic flux satisfies a threshold to tell the change from noise. For example, where the change of the magnetic field or the magnetic flux detected by the magnetic sensor 112 is below the threshold, the garage status monitoring garage door status monitoring engine 121 can determine that the garage door opener 210 has not started any opening or closing operation. The garage door status monitoring engine 121 generates the second status information indicating that the garage door opener 210 has not started any operation. Alternatively, where the change of the magnetic field or the magnetic flux detected by the magnetic sensor 112 is the same or above the threshold, the garage door status monitoring engine 121 can determine that the garage door opener 210 has started opening or closing operation of the garage door 220. The garage door status monitoring engine 121 generates the second status information indicating that the garage door opener 210 has started an operation.

Where there are other current sources, e.g., aside from the motor of the garage door opener 210, that can influence the magnetic sensor 112, the garage door status monitoring engine 121 can determine whether current detected by the magnetic sensor 112 is induced by the motor of the garage door opener or by other current sources. Any suitable techniques can be used to improve the accuracy of the garage door status monitoring engine 121. In some implementations, the garage door status monitoring engine 121 can store multiple thresholds. For example, where the garage door opener 210 includes a light bulb, the garage door status monitoring engine 121 can store a first threshold corresponding to current for operating only the light bulb, a second threshold corresponding current for operating only the motor of the garage door opener 210, and a third threshold corresponding current for operating both the light bulb and the motor of the garage door opener 210. In this example, the garage door status monitoring engine 121 determines that the garage door opener 210 has started when the current change detected by the current sensor 111 or the magnetic sensor 112 satisfies the second threshold or the third threshold.

The garage door status monitoring engine 121 can determine that the current change satisfies the second threshold or the third threshold by comparing the threshold values to a value of peak current that has been induced for a certain time period since a current change was detected by the current sensor 111 or the magnetic sensor 112. In some other implementations, the garage door status monitoring engine 121 can compare the threshold values to a median value of current that has been induced for a certain time period since a current change was detected by the current sensor 111 or the magnetic sensor 112.

The garage door monitoring system 100 can determine the values of the first threshold, the second threshold, and the third threshold based on initial calibration information. For example, the garage door monitoring system 100 can initially obtain the calibration information, e.g., current detected by the current sensor 111 or the magnetic sensor 112, while the garage door 220 is fully opened and closed. Where the garage door opener 210 includes a light bulb, the initial calibration information may include three groups of current levels, (i) a first group of current levels that corresponds to current for operating the light bulb, (ii) a second group of current levels that corresponds to current for operating the motor of the garage door opener 210, and (iii) a third group of current levels that corresponds to current for operating both the light bulb and the motor of the garage door opener 210. The garage door monitoring system 100 can cluster each of these groups of current levels to the respective threshold value.

In some other implementations, the garage door status monitoring engine 121 can store multiple reference characteristics of current, e.g., waveforms of current, corresponding to characteristics of current for operating only the light bulb, characteristics of current for operating only the motor of the garage door opener 210, and characteristics of current for operating both the light bulb and the motor of the garage door opener 210. The garage door status monitoring engine 121 can determine that the garage door opener 210 has started by comparing the reference characteristics to a characteristic of current detected by the current sensor 111. Thus, even if the light bulb is turned on and causes current change in the detecting device 110, the garage door status monitoring engine 121 can determine that the garage door opener 210 has not started any operation.

Third Status Information

The garage door status monitoring engine 121 determines how long the garage door opener 210 has operated since the garage door opener 210 started the initial operation. This time duration is defined as a transition time. For example, if the garage door opener 210 begins an opening operation and the operation lasts for 5 seconds, the transition time is 5 seconds. The server 120 can store expected transition times for all transitions in the storage 123. An expected transition time indicates a time duration for, fully or partly, opening or closing the garage door 220. For example, if it takes 10 seconds that the garage door 220 is moved from open status to closed status, the expected transition time for a closing operation is 10 seconds.

In some implementations, the server 120 can provide a graphic user interface running on the user device 300, which allows a user to set up the expected transition time. For example, the graphic user interface can provide a measuring mode. Using the measuring mode, the user can measure the expected transition times for all transition operations. When the user device 300 completes the measuring, the user device 300 provides the expected transition times to the server 120. The server 120 can store the expected transition times in the storage 123. When the user changes a garage door opener, the user may want to update the expected transition times. If the user requests to update the stored expected transition time, the server 120 can provide the graphic user interface for measuring the expected transition time to update the expected transition time.

When the garage door status monitoring engine 121 stores the expected transition times, the garage door status monitoring engine 121 can determine whether garage door status is changed based on the transition time and the expected transition time. For example, where (i) the initial status of the garage door 220 is closed, (ii) the garage door 220 has started an operation, and (iii) an expected transition time from closed status to open status is 10 seconds, the garage door status monitoring engine 121 can determine that the garage door 220 is fully open when 10 seconds have lapsed since the garage door opener 210 started the initial operation. For another example, where (i) the initial status of the garage door 220 is open, (ii) the garage door 220 has started an operation, and (iii) an expected transition time from closed status to open status is 10 seconds, the garage door status monitoring engine 121 can determine that the garage door 220 is closing when 3 seconds have lapsed since the garage door opener 210 started the initial operation.

In some implementations, based on the transition time, the garage door status monitoring engine 121 can determine whether the garage door status is fully or partly opened. For example, where the expected transition time is 10 seconds, the garage door status monitoring engine 121 can determine that the garage door 220 is partly opened when 3 seconds have elapsed since the garage door opener 210 started the initial operation.

In some implementations, based on the transition time, the garage door status monitoring engine 121 can determine the height of the garage door 220 opened. For example, where the expected transition time is 10 seconds and the total height of the garage door 220 is 8 feet, (e.g., as provided by the user), the garage door status monitoring engine 121 can determine that the height of the garage door 220 opened is 4 feet when 5 seconds have lapsed since the garage door opener 210 started the initial operation.

In some implementations, the garage door status monitoring engine 121 can store multiple expected transition times to improve the accuracy of the garage door status monitoring engine 121. For example, where the garage door opener 210 includes a light bulb, the garage door status monitoring engine 121 can store a first expected transition time, e.g., 30 seconds, for operating the light bulb and a second expected transition time, e.g., 10 seconds, for operating a motor of the garage door opener 210. The garage door status monitoring engine 121 can determine whether current detected by the current sensor 111 is for operating the motor of the garage door opener 210 or for operating the light bulb based on a transition time, the first expected transition time, and the second expected transition time. In this example, if 15 seconds have elapsed since the current sensor 111 detected current provided to the garage door opener 210, the garage door status monitoring engine 121 can determine that the current is for operating the light bulb, not for operating the motor of the garage door opener 210.

State Machine

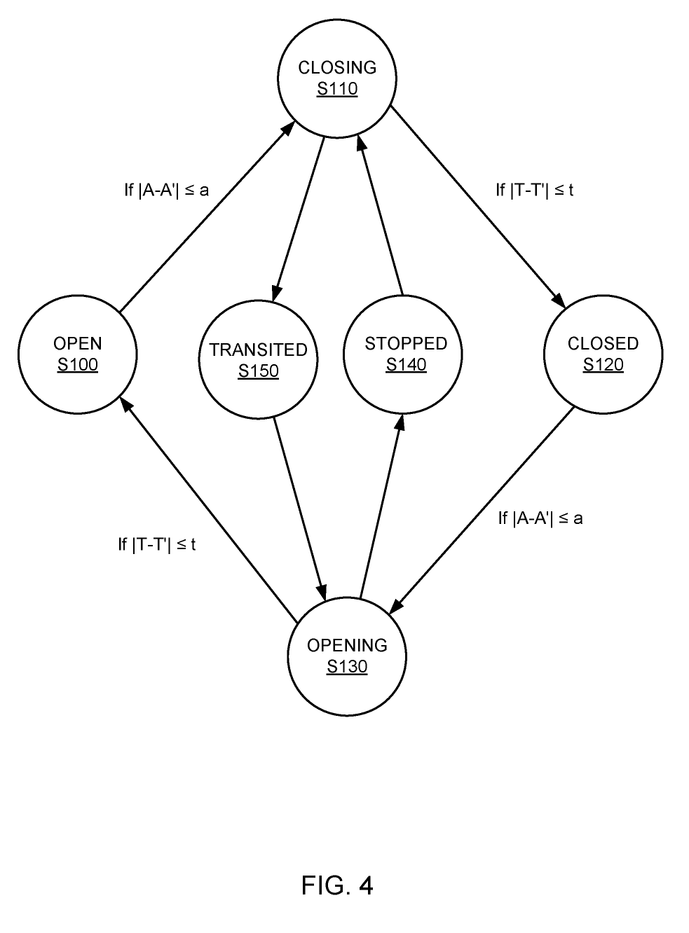

FIG. 4 is a diagram illustrating an example state machine for a garage door status monitoring engine. After the garage door status monitoring engine 121 determines the initial status of the garage door 220, the garage door status monitoring engine 121 can determine the current status of the garage door 220 based on this example state machine. For example, where the initial status is one of OPEN (S100), CLOSING (S110), CLOSED (S120), OPENING (S130), STOPPED (S140), and TRANSITED (S150), the garage door status monitoring engine 121 can determine the next status following the initial status based on the state machine.

When the initial status of the garage door 220 is OPEN (S100), the garage door status monitoring engine 121 determines whether the garage door opener 210 has started an operation. In some implementations, the garage door status monitoring engine 121 can compare detected current (A′) provided from the power source 240 to the garage door opener 210 to a threshold (A). If the difference between the detected current (A′) and the threshold (A) is equal or smaller than an error margin (a), the garage door status monitoring engine 121 determines that the garage door opener 121 has started an operation and change the current status from OPEN (S100) to CLOSING (S110).

In some other implementations, the garage door status monitoring engine 121 can compare a detected magnetic field or a detected magnetic flux (A′) caused by current provided from the power source 240 to the garage door opener 210 to a threshold (A). If the difference between the detected magnetic field or the detected magnetic flux (A′) and the threshold (A) is equal or smaller than an error margin (a), the garage door status monitoring engine 121 determines that the garage door opener 121 has started an operation and change the current status from OPEN (S100) to CLOSING (S110).

At CLOSING (S110), the garage door status monitoring engine 121 determines whether an expected transition time has elapsed since the garage door opener 121 started the initial operation. The garage door status monitoring engine 121 can compare the transition time (T) to the expected transition time (T′). If the difference between the transition time (T) and the expected transition time (T′) is equal or smaller than an error margin (t), the garage door status monitoring engine 121 determines that the expected transition time has elapsed and change the current status from CLOSING (S110) to CLOSED (S120).

At CLOSING (S110), when the difference between the transition time (T) and the expected transition time (T′) is larger than the error margin (t), that is, when the expected transition time has not elapsed, the server 120 may receive updated garage door status data from the detecting device 110. This may occur when a user changes the direction of operation while the garage door 220 is closing. For example, when the user finds something under the garage door 220 that partially obstructs the door path, the user may quickly control a remote controller to open the garage door 220. When the direction of motor operations changes, the direction change effects on the characteristics of the current provided to the garage door opener 220. The characteristics of the current may include changes in waveform of current such as spike, overshot, jitter, temporal drop and time period between the changes in waveform of current. The detecting device 110 detects this current change and sends the current data to the server 120. When the server 120 receives the current data, the garage door status monitoring engine 121 determines that the current status of the garage door 220 is opening. Thus, the garage door status monitoring engine 121 changes the current status from CLOSING (S110) to TRANSITED (S150), and then from TRANSITED (S150) to OPENING (S130).

When the initial status of the garage door 220 is CLOSED (S120), the garage door status monitoring engine 121 determines whether the garage door opener 210 has started an operation. In some implementations, the garage door status monitoring engine 121 can compare detected current (A′) provided from the power source 240 to the garage door opener 210 to a threshold (A). If the difference between the detected current (A′) and the threshold (A) is equal or smaller than an error margin (a), the garage door status monitoring engine 121 determines that the garage door opener 121 has started an operation and change the current status from CLOSED (S120) to OPENING (S130).

In some other implementations, the garage door status monitoring engine 121 can compare a detected magnetic field or a detected magnetic flux (A′) caused by current provided from the power source 240 to the garage door opener 210 to a threshold (A). If the difference between the detected magnetic field or the detected magnetic flux (A′) and the threshold (A) is equal or smaller than an error margin (a), the garage door status monitoring engine 121 determines that the garage door opener 121 has started an operation and change the current status from CLOSED (S120) to OPENING (S130).

At OPENING (S130), the garage door status monitoring engine 121 determines whether the expected transition time has elapsed since the garage door opener 121 started the initial operation. The garage door status monitoring engine 121 can compare the transition time (T) to the expected transition time (T′). If the difference between the transition time (T) and the expected transition time (T′) is equal or smaller than an error margin (b), the garage door status monitoring engine 121 determines that the expected transition time has elapsed and change the current status from OPENING (S130) to OPEN (S100).

At OPENING (S130), when the difference between the transition time (T) and the expected transition time (T′) is larger than the error margin (t), that is, when the expected transition time has not elapsed, the server 120 may receive updated garage door status data from the detecting device 110. This may occur when a user changes the direction of operation while the garage door 220 is opening. For example, when the user mistakenly opens the garage door 220, the user may stop the opening operation and close the garage door 220. When the direction of motor operations changes or the motor stops, the change or the stop effects on the characteristics of the current provided to the garage door opener 220. The characteristics of the current may include changes in waveform of current such as spike, overshot, jitter, temporal drop and time period between the changes in waveform of current. The detecting device 110 detects this current change and sends the current data to the server 120. When the server 120 receives the current data, the garage door status monitoring engine 121 determines that the current status of the garage door 220 is closing. Thus, the garage door status monitoring engine 121 changes the current status from OPENING (S110) to STOPPED (S140), and then from STOPPED (S140) to CLOSING (S110).

Recovery Process

While the garage door 220 is being closed or is being opened, if the garage door monitoring system 100 cannot determine current status of the garage door 220 based on the state machine described with reference to FIG. 4, the garage door monitoring system 100 can begin a recovery process.

In some implementations, where the garage door monitoring system 100 maintains the most recent status of the garage door 220, the garage door monitoring system 100 can determine the current status of the garage door 220 based on (i) the most recent status of the garage door 220 and (ii) the time duration that the garage door 220 has stopped.

Where the most recent status of the garage door 220 is CLOSING (S110), the garage door monitoring system 100 can determine the current status by comparing the time duration that the garage door 220 has stopped to multiple thresholds including a first threshold and a second threshold that is larger than the first threshold. For example, if the time duration is less than the first threshold, the garage door monitoring system 100 can determine that the current status is CLOSING (S110). If the time duration is equal or more than the first threshold, but less than the second threshold, the garage door monitoring system 100 can determine that the current status is TRANSITED (S150). If the time duration is more than the second threshold, the garage door monitoring system 100 can determine that the current status is CLOSED (S120).

Where the most recent status of the garage door 220 is OPENING (S130), the garage door monitoring system 100 can determine that the current status is OPEN (S100).

In some implementations, the garage door monitoring system 100 can determine the current status of the garage door 220 based on previous user behaviors. For example, when the garage door 220 stopped while the garage door 220 was being closed, if a user previously opened the garage door 220, the garage door monitoring system 100 can store this information. The garage door monitoring system 100 can determine that the current status is OPEN (S100) using the information when the garage door 220 has stopped while the garage door 220 is being closed.

Secured Connection

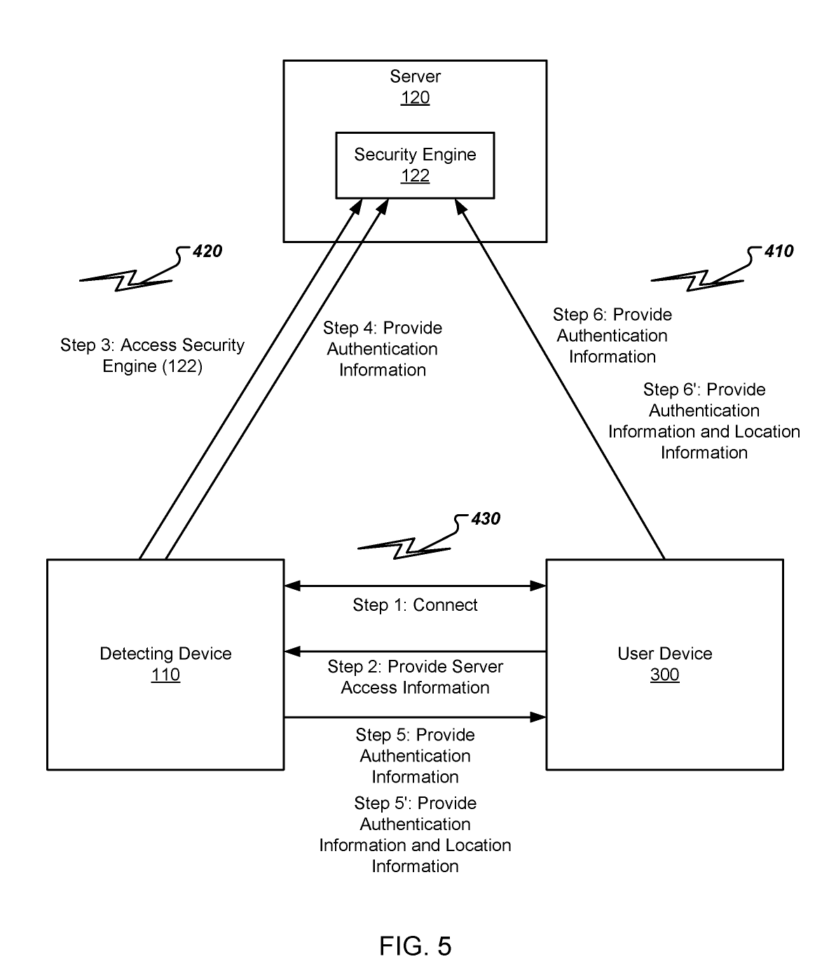

FIG. 5 is a diagram illustrating an example method of establishing secured connections among a user device, a detecting device, and a server. The security engine 122 of the server 120 is configured to communicate with the detecting device 110 and the user device 300 to establish secured connections.

When the detecting device 110 is coupled to the power source 240, the detecting device 110 is configured to be connected with the user device 300 over the one or more third networks 430 (Step 1). In some implementations, the detecting device 110 is connected with the user device 300 using an application or a computer program running on the user device 300. In some implementations, when the detecting device 110 is connected with a different user's device such as an intruder's device, the detecting device 110 can be configured to be reset based on a true user's request. When the detecting device 110 is reset, the detecting device 110 can be connected with the user device 300, which is the true user's device.

The one or more third networks 430 can be phone and/or computer networks including wireless cellular networks, WLAN or Wi-Fi networks, wired Ethernet networks, other wired networks, or any suitable combination thereof. In some implementations, the one or more third networks 430 can be different from the one or more first networks 410 or the one or more third networks 430. For example, the first networks 410 can be wireless cellular networks, the third networks 430 can be wired networks, and the third networks can be Wi-Fi networks. In some other implementations, the one or more first networks 410, the one or more third networks 430, and the one or more third networks 430 can be the same networks. For example, all of the first networks 410, the third networks 430, and the third networks 430 can be wireless cellular networks.

The user device 300 provides server access information to the detecting device 110 (Step 2). For example, the server access information may include Wi-Fi SSID and password stored in the user device 300. The detecting device 110 can access the security engine 122 using the server access information (Step 3).

The detecting device 110 provides authentication information to the security engine 122 (Step 4). The authentication information can be encrypted and stored in the detecting device 110.

The detecting device 110 provides the authentication information to the user device 300 (Step 5). The user device 300 provides the authentication information to the security engine 122 (Step 6). Thus, the security engine 122 can match the two authentication information provided by the detecting device 110 and the user device 300 to verify that the user device 300 is a user device connected with the detecting device 110.

In some implementations, the detecting device 300 can provide the authentication information and location information (Step 5′). The location information may include an IP address that the detecting device 110 uses to access the security engine 122. The user device 300 also provides the authentication information and the location information to the security engine 122 (Step 6′). Assuming that the user device 300 uses the same network with the detecting device 110, the security engine 122 can match the two location information provided by the detecting device 110 and the user device 300 to verify that the user device 300 is a user device connected with the detecting device.

Other Implementations

Methods of detecting garage door status data using sensors described with regard to FIG. 2 and methods of determining current status of garage door with regard to FIG. 3 can be applied to other implementations such as an electric stove. For example, a detecting device is coupled between an electric stove and a power source and detects current provided from the power source to the electric stove. The detecting device can send the detected data to a server. The server is configured to determine current status of the electric stove and send notifications to a user device.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media, e.g., multiple CDs, disks, or other storage devices.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processing unit, a computer, a system on a chip, a personal computer system, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, or in general any type of computing or electronic device, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processing units executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processing units suitable for the execution of a computer program include, by way of example, both general and special purpose microprocessors, and any one or more processing units of any kind of digital computer. Generally, a processing unit will receive instructions and data from a read-only memory or a random access memory or both. The essential elements of a computer are a processing unit for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, a network routing device, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processing unit and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or a routing device, e.g., a network router, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs executing on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what can be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous. Accordingly, other embodiments are within the scope of the following claims.

What is claimed is:

1. A method comprising:
obtaining garage door status data from one or more sensors;
generating first status information based on the garage door status data, the first status information indicating initial status of a garage door;
generating second status information based on the garage door status data, the second status information indicating that a garage door opener has started an operation;
generating third status information based on the garage door status data, the third status information indicating a time duration that the garage door opener has operated since the garage door opener started an operation; and
determining current status of the garage door based on (i) the first status information, (ii) the second status information, and (iii) the third status information.

2. The method of claim 1, wherein the garage door status data includes a value of current, obtaining garage door status data comprising:
sensing current provided from a power source to the garage door opener.

3. The method of claim 1, wherein the garage door status data includes magnetic information including a value of a magnetic field or a value of a magnetic flux, obtaining garage door status data comprising:
obtaining the magnetic information near a current line connecting a power source to the garage door opener.

4. The method of claim 1, wherein the garage door status data includes images, obtaining garage door status data comprising:
obtaining images of the garage door.

5. The method of claim 1, wherein the garage door status data includes sound data, obtaining garage door status data comprising:
detecting sound inside a garage.

6. The method of claim 1, wherein generating first status information based on the garage door status data comprises:
determining characteristics of the garage door status data, and
determining the initial status of the garage door based on the characteristics of a current.

7. The method of claim 6, wherein the characteristics of the garage door status data include a waveform of a current, brightness of an image, contrast of an image, or a sound pattern.

8. The method of claim 1, wherein generating second status information based on the garage door status data comprising:
determining whether the garage door status data satisfies a threshold, and
determining whether the garage door opener has started an operation based on the determination that the garage door status data satisfies the threshold.

9. The method of claim 1, wherein determining current status of the garage door comprises:
determining the time duration that the garage door opener has operated since the garage door opener started an operation satisfies one or more thresholds.

10. The method of claim 1, further comprising:
providing the current status of the garage door to an external device.

11. The method of claim 1, further comprising:
obtaining, by a detecting device from an external device, server access information;
accessing, by the detecting device, a server using the server access information;
providing, by the detecting device to the server, authentication information; and
providing, by the detecting device to the external device, the authentication information.

12. The method of claim 11, wherein the detecting device further provides location information to the server and the external device.

13. The method of claim 1, further comprising:
receiving the current status of the garage door;
generating a first notification based on the current status of the garage door; and
providing the first notification to a vehicle system.

14. The method of claim 1, further comprising:
receiving the current status of the garage door;
obtaining contextual information that is associated with a user behavior, a user location, user preferences, or a user schedule;
generating a second notification based on the current status of the garage door and the contextual information; and
provide the second notification to a vehicle system.

15. The method of claim 1, further comprising:
receiving, from a detecting device by a receiver, the current status of the garage door;
receiving, from the detecting device by the receiver, a radio signal, a strength of the radio signal varies based on a distance between the detecting device and the receiver;
determining a vehicle location based on the radio signal;
generating contextual information that is associated with the vehicle location;
generating a second notification based on the current status of the garage door and the contextual information; and
providing the second notification to a vehicle system.

16. The method of claim 15, further comprising:
obtaining magnetic information from a vehicle near the garage door; and
updating the contextual information that is associated with a vehicle location based on the magnetic information.

17. The method of claim 1, further comprising:
determining whether the current status of the garage door can be determined based on (i) the first status information, (ii) the second status information, and (iii) the third status information; and
performing, based on the determination that the current status of the garage door can be determined based on (i) the first status information, (ii) the second status information, and (iii) the third status information, a recovery process using a most recent current status of the garage door and a time duration that the garage door has stopped.

18. The method of claim 17, wherein performing a recovery process using a most recent current status of the garage door comprises:
obtaining one or more threshold values;
comparing each value of the one or more threshold values to the time duration that the garage door has stopped; and
determining the current status of the garage door based on results of comparing each value of the one or more threshold values to the time duration.

19. The method of claim 1, further comprising:
receiving a request to open the garage door;
obtaining size information of a package; and
opening the garage door based on the size information of the package.

20. The method of claim 19, further comprising:
obtaining a delivery schedule of the package;
determining whether the package is scheduled to be delivered based on the delivery schedule;
determining whether the garage door is opened or closed based on the determination that the package is scheduled to be delivered;
generating a notification indicating whether the garage door is opened or closed based on the determination that the garage door is opened; and
providing the notification to a vehicle system or a user device.
